(19) United States
(12) Patent Application Publication
(10) Pub. No.: US 2011/0295668 A1
(43) Pub. Date: Dec. 1, 2011

(54) MANAGEMENT OF ADVERTISING RELATED DATA ON NETWORKED MOBILE COMPUTING DEVICES

(76) Inventors: Nabyl Charania, Hallandale Beach, FL (US); Michael Leitman, Hallandale Beach, FL (US); George Morfidis, Hollywood, FL (US)

(21) Appl. No.: 12/790,807

(22) Filed: May 29, 2010

(51) Int. Cl. G06Q 30/00

(52) U.S. Cl. 705/14.13

(57) ABSTRACT

The present invention discloses a method for managing advertising related data over a distributed computer network, wherein the method includes receiving from an advertiser at least one data record defining a coupon and target data specifying demographics for targeting the coupon. The method further includes receiving from the consumers identifying data, demographic data and purchase preference data and providing to each consumer a coupon based on the demographic data, preference data and target data. The method further includes entering the consumers in a sweepstakes and receiving validation notices confirming that a plurality of coupons was utilized by a subset of the consumers at the advertiser via a purchase. The method further includes receiving from an advertiser a request to view aggregate data representing coupon provision and coupon validation and generating a data record including aggregate data representing coupon provision and coupon validation according to demographic data.

### BACKGROUND OF THE INVENTION

1. Field of the Invention

The present invention relates to the field of advertising and marketing and more specifically, the present invention relates to the field of scalable systems for managing advertising and marketing data on electronic devices.

2. Description of the Related Art

Historically, the only methods for advertisers to showcase their products and services have been print media and in-person advertising and marketing. With the birth of the electronic age, however, a plethora of additional options became available for businesses seeking to advance their brands. With the emergence of radio and television, for example, advertisers gained access to previously unavailable technologies—radio frequency-transmitted audio and video spots. In the same thread, the internet now affords advertisers with additional venues for reaching consumers. Videos including synchronized audio, banner ads and hyperlinked text ads, for example, are now ubiquitous advertising methods on the web.

The next frontier for advertising and marketing is networked computing devices, such as mobile smart-phones and kiosks. All of the modes of advertising on the web are available on networked computing devices. The ability to address a largely unexplored aspect of advertising—in-location or in-area advertising—however, is particularly, addressed by networked computing devices, both mobile and non-mobile. The concept of in-location or in-area advertising pertains to the use of advertising and marketing methods directed to consumers while they are physically located in or near a place where the advertiser's goods can be purchased. One example of in-location advertising is the use of physical banners hung from utility poles within a pedestrian shopping area, wherein the banner advertises a current sale or promotion at a local store. Another example of in-location advertising is the use of a kiosk within a shopping mall, wherein the kiosk provides coupons for use at a mall store.

Various solutions currently exist for executing in-location advertising using networked computing devices. One solution involves the use of kiosks, comprising a conventional computer, which provide coupons and advertisements for a store or stores in a shopping location. Another solution involves the transmission of advertisements, including banner ads or text messages, transmitted to a consumer's mobile phone when the mobile phone is detected at or near a store corresponding to the advertisement. The solutions above, however, have their drawbacks.

One problem with the solutions defined above is their limited ability to drive consumers to the store. Although a coupon or advertisement can be enticing for a consumer at or near the location of the store being marketed, there lacks an added motivation for the consumer to visit the store in person, other than the subject of the coupon or advertisement. Another problem with conventional solutions for in-location advertising is the lack of a comprehensive system for managing data that is gathered by the kiosk or mobile device, such as data entered by a consumer. This problem is compounded when the number of kiosks and/or mobile devices being monitored, as well as the amount of data collected from each unit, increases. Yet another problem with conventional solutions is the lack of a straightforward method for managing data that is uploaded to each kiosk or mobile device, such as ads and coupons. Again, this problem is compounded with an increasing number of kiosks and mobile devices, as well as with an increasing number of ads and coupons. Lastly, a problem with conventional solutions is the lack of a scalable system for managing the effectiveness or use of ads and coupons provided to consumers.

Therefore, what is needed is a system and method for improving the problems with the prior art, and more particularly for a more effective in-location advertising method and a more efficient method and system for managing advertising data, marketing data and related information on networked computing devices.

### BRIEF SUMMARY OF THE INVENTION

In one embodiment, the present invention discloses a method for managing advertising related data over a distributed computer network, wherein the method includes receiving from an advertiser, via a network connection, at least one data record, wherein each data record defines a coupon and target data specifying demographics for targeting the coupon. The method further includes receiving from each of a plurality of consumers, via the network connection, identifying data, demographic data and purchase preference data and providing to each of the plurality of consumers a coupon based on the demographic data of the consumer, the preference data of the consumer and the target data of the advertiser. The method further includes entering each of the plurality of consumers in a sweepstakes and receiving, via the network connection, a plurality of validation notices confirming that a plurality of coupons was utilized by a subset of the plurality of consumers at the advertiser via a purchase. The method further includes receiving from an advertiser, via a network connection, a request to view aggregate data representing coupon provision and coupon validation and generating a data record including aggregate data representing coupon provision and coupon validation according to demographic data.

In another embodiment, the present invention discloses a computer system for managing advertising related data over a distributed computer network, wherein the computer system includes a processor configured for receiving from an advertiser, via a network connection, at least one data record, wherein each data record defines a coupon and target data specifying demographics for targeting the coupon. The processor is further configured for receiving from each of a plurality of consumers, via the network connection, identifying data, demographic data and purchase preference data and providing to each of the plurality of consumers a coupon based on the demographic data of the consumer, the preference data of the consumer and the target data of the advertiser. The processor is further configured for entering each of the plurality of consumers in a sweepstakes and receiving, via the network connection, a plurality of validation notices confirming that a plurality of coupons was utilized by a subset of the plurality of consumers at the advertiser via a purchase. The processor is further configured for receiving from an advertiser, via a network connection, a request to view aggregate data representing coupon provision and coupon validation and generating a data record including aggregate data representing coupon provision and coupon validation according to demographic data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing in-location advertising and advertising data management over a communications network, in accordance with one embodiment of the present invention.

FIG. 2 is a block diagram showing the various data that is entered, stored, processed and managed according to one embodiment of the present invention.

FIG. 3 is a flow chart describing the control flow of a process for providing targeted advertising to consumers over a communications network, in accordance with one embodiment of the present invention.

FIG. 4 is a flow chart describing the control flow of a process for managing advertising related data over a communications network, in accordance with one embodiment of the present invention.

### DETAILED DESCRIPTION OF THE INVENTION

The present invention improves upon the problems with the prior art by providing a more effective in-location advertising method and providing a more efficient method and system for managing advertising data, marketing data and related information on networked computing devices, both mobile and non-mobile. In one embodiment, the present invention provides a novel method involving a computing device, such as a kiosk, wherein consumers enter personal data into the kiosk, the kiosk provides the consumer a targeted ad or coupon based on the personal data, the consumer is entered into a periodic giveaway and the use of the coupon at the advertised store is recorded. The aforementioned method provides an incentive for consumers to visit advertised stores in person by providing a monetary discount and by offering a giveaway or sweepstakes. Further, the aforementioned method provides an incentive for consumers to continuously log onto or visit an online location provided by the present invention by offering participation in running or ongoing sweepstakes and giveaways. Lastly, the aforementioned method provides an incentive for consumers to return to the kiosk location, thereby enticing the consumer to return to the shopping location, by offering participation in ongoing sweepstakes and giveaways.

Additionally, the present invention provides a scalable and easy-to-use system for allowing advertisers (e.g., stores), location owners (e.g., shopping malls) and administrators of the system to log onto a central server/repository to manage and view ads and coupons, data entered by consumers, survey questions, giveaways/sweepstakes, and sales data attributed to coupons. More specifically, advertisers, location owners and administrators can view and analyze ad impressions, coupon use, fees paid for the advertising, and revenue received from the advertising. Data can be analyzed and viewed in total, by demographic data, by advertiser, by location and by kiosk. In this way, the present invention improves over the prior art by providing a scalable and centrally networked system for managing various types of data that is uploaded to the kiosks (ads, ad targets, survey questions, etc.). The present invention further improves over the prior art by providing a centralized system for gathering and managing the data that is entered by consumers at the kiosks, such as demographic data and preference data. Lastly, the present invention further improves over the prior art by providing a centralized system for gathering and managing sales data related to use of the coupons provided by the system.

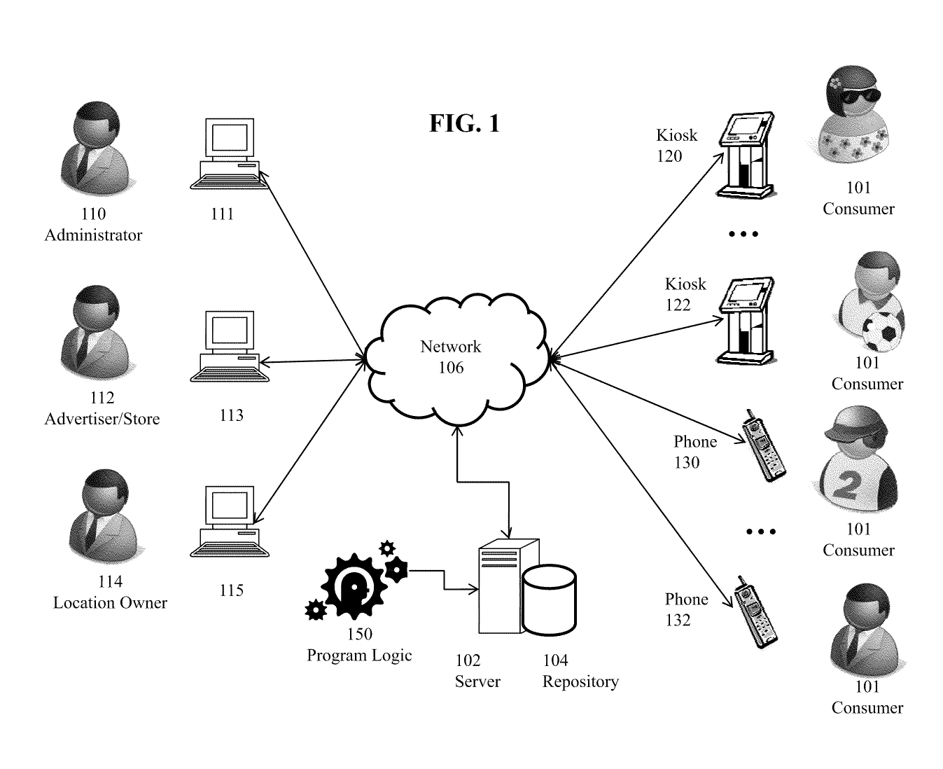

Referring now to the drawing figures in which like reference designators refer to like elements, there is shown in FIG. 1 an illustration of a block diagram showing the network architecture of a software application in accordance with the principles of the present invention. The most prominent element of FIG. 1 is the server 102 associated with repository or database 104 and further coupled with network 106, which can be a circuit switched network, such as the Public Service Telephone Network or a packet switched network such as the Internet or the World Wide Web. Server 102 is a central controller or operator for the functionality that executes on kiosks 120-122 and phones 130-132, namely, the provision of coupons and ads, survey questions, games, giveaways and/or sweepstakes, all of which are provided to the consumers 101, wherein the provision of the foregoing provides a monetary and recreational motivation for consumers 101 to interact with kiosks 120-122 and phones 130-132.

FIG. 1 further includes mobile smart-phones or cellular phones 130-132 and kiosks 120-122, wherein a kiosk comprises a networked computer system that may include a display, speakers, a touch screen, input devices, etc. Consumers 101 interact with phones 130-132 and kiosks 120-122. FIG. 1 also includes client computers or workstations 111, 113 and 115, with which various entities 110, 112, 114, respectively, interact. Client computer 111 corresponds to an administrator 110, who may perform supervisory or administrative tasks on server 102. Client computer 113 corresponds to an advertiser or store 112, which refers to a business entity, such as a store, a brand or a service provider, that seeks to advertise and market to consumers 101 via server 102. Client computer 115 corresponds to a location owner 114, which refers to the owner of a place, such as a shopping mall or a theme park, housing or including various advertisers or stores 112. Location owner 114 may also pertain to the owner of taxi cabs, buses, as stations, convention centers, etc.

FIG. 1 shows an embodiment of the present invention wherein client computers 111, 113, 115 and networked computing devices 120-122, 130-132 interact with server 102 and repository 104 over the network 106. Server 102 includes a software engine that delivers applications, data, program code and other information to client computers 111, 113, 115 and networked computing devices 120-122, 130-132. The software engine of server 102 may perform other processes such as video streaming or other standards for transferring multimedia data in a stream of packets that are interpreted and rendered by a software application as the packets arrive. It should be noted that although FIG. 1 shows only three client computers 111, 113, 115 and four networked computing devices 120-122, 130-132, the system of the present invention supports any number of client computers and networked computing devices connected via network 106.

In one embodiment of the present invention, the application provided by the server 102 of FIG. 1 is a client-server application having a client portion that resides on a client computer (i.e., 111, 113, 115, 102-122, 130-132) and a server application that resides on server 102. For example, the application can be a web interface that is accessed by a client computer, such as client computer 111, via network 106. The application served by server 102 may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

FIG. 1 further shows that server 102 includes a database or repository 104. Client computers 111, 113, 115, 102-122, 130-132 may also each include their own database. The repository 104 serves data from a database, which is a repository for data used by server 102 and the client computers during the course of operation of the invention.

Server 102 includes program logic 150 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 150 may reside on a client computer, the server 102 or any combination of the two.

Note that although server 102 is shown as a single and independent entity, in one embodiment of the present invention, the functions of server 102 may be integrated with another entity, such as one of the client computers. Further server 102 and its functionality, according to a preferred embodiment of the present invention, can be realized in a centralized fashion in one computer system, or in a distributed fashion where different elements are spread across several interconnected computer systems.

The network architecture of FIG. 1 in accordance with the principles of the present invention may give rise to various revenue-generating arrangements. The advertisers 112, for example, may pay an ongoing or per-transaction fee to the operators of server 102 in exchange for the coupons and/or ad impressions that are presented to consumers 101 via the kiosks 120-122 and phones 130-132. In another example, the location owner 114 may be paid an ongoing or per-transaction fee by the operators of server 102 in exchange for the placement of the kiosks 120-122 at the owner's location. In yet another example, a cellular phone provider or cellular service provider may be paid fees by the operators of server 102 in exchange for the placement of the applicable software on the phones 130-132. Lastly, the consumer 101 may pay the operators of server 102 for access to the coupons, ads and giveaways available on kiosks and/or phones.

Note also that although FIG. 1 shows consumers 101 interacting only with networked kiosks 120-122 and phones 130-132, the present invention also supports consumers 101 interacting with networked desktop, laptop and pad computers. In this embodiment, consumers 101 communicate with server 102, and its functionality, via desktop, laptop and pad computers that are connected to the network 106.

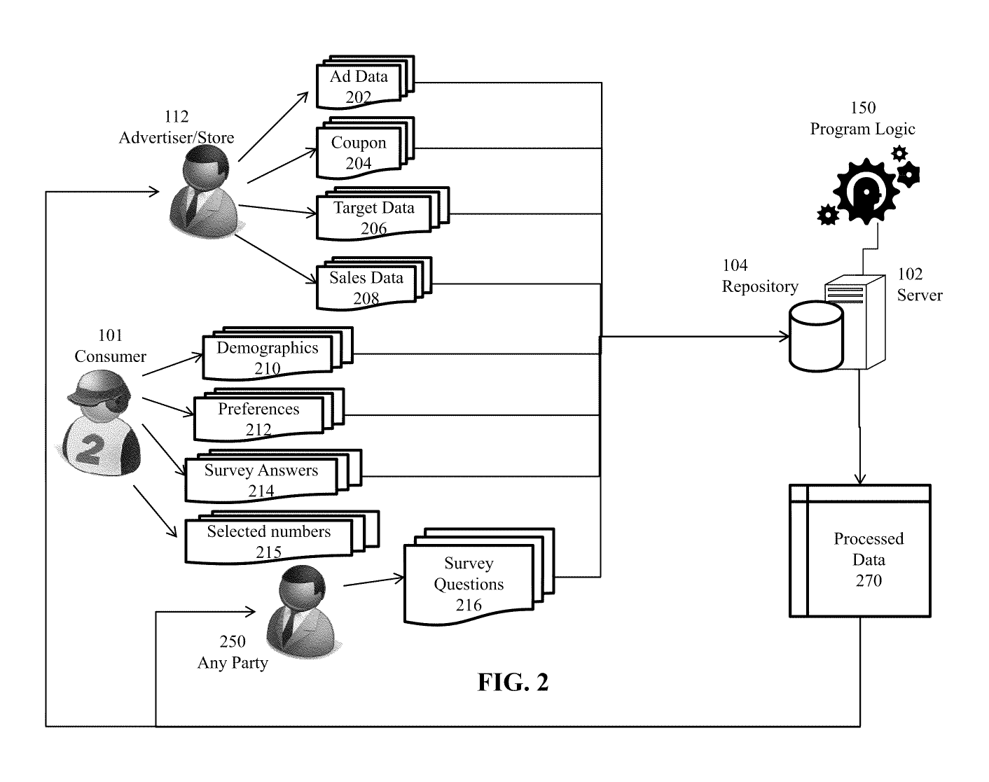

FIG. 2 is a block diagram showing the various data that is entered, stored, processed and managed according to one embodiment of the present invention. FIG. 2 shows that advertiser 112 may enter various data sets into repository 102 for processing and management by program logic 150 on server 102. Advertiser 112 may enter ad data 202, which refers to data that comprises an ad, such as graphics, video, text, a product identifier, a store identifier, an expiration date, etc. Advertiser 112 may also enter coupon data 204, which may include the same data as set 202 but further including a discount amount, a discount time period, etc. Target data 206 specifying demographics to which the coupon or ad is targeted may also be entered by advertiser 112. Target data 206 may also include preferences for individual kiosks, phones and/or entire locations (i.e., a shopping mall) or region to which the advertiser 112 may desire to target his ads and coupons. Data sets 202, 204 and 206 may be entered into repository 104 by the advertiser 112 via its client computer 111, a mobile app or a similar means.

Lastly, sales data 208 may be entered by the advertiser or store 112. Sales data 208 refers to a certification or a validation by the store 112 when a coupon issued by the present invention is redeemed or used at the store 112. Thus, when a coupon is redeemed by a consumer 101, the store 112 may log the coupon redemption and/or the related sale of merchandise or service into repository 104 via its client computer 111, a mobile app or a similar means. Sales data 208 may also include an individual store identifier, a purchased product identifier, a consumer identifier, a coupon identifier, etc. In this way, the effectiveness of the coupons 204 and ads 202 may be measured.

FIG. 2 further shows that consumer 101 may also enter various data sets into repository 102 for processing and management by program logic 150 on server 102. First, the consumer 101 may enter identifying data, such as his name, email address, etc. Consumer 101 may enter demographics data 210, such as age, sex, income level, race, educational attainment, employment status, etc. Consumer 101 may also enter preference data 212, such as preferred clothing type, preferred food type, the reason for the consumer's current visit, etc. Also, the consumer 101 may enter answers to survey questions 214 provided to the consumer via the kiosk 120-122 or mobile phone 130-132. Lastly, the consumer 101 may select numbers or symbols 215 for entering into a sweepstakes, giveaway or promotional via the kiosk 120-122 or mobile phone 130-132. Data sets 210, 212, 214, 215 may be entered into repository 104 by the consumer 101 via kiosks 120-122, mobile phones 130-132 or a similar means.

Lastly, any party 250, including the administrator 110, the advertiser 112 and the location owner 114, may enter survey questions provided to the consumers 101 via the kiosk 120-122 or mobile phone 130-132. Survey questions 216 may be entered into repository 104 via a client computer 111, 113 or 115, a mobile app or a similar means.

The data sets entered by the various parties may be processed by program logic 150 on server 102 and presented for viewing to administrator 110, advertiser 112 and location owner 114 as processed data 270 via network 106. Processed data 270 may be processed so as to provide compilations or aggregations of the data sets entered by various users into repository 104, such as trend data. Processed data 270 may further be processed using any statistical technique to aid interpretation of data. Program logic 150 may also provide for differing views of the processed data 270. For example, the advertiser 112 may log on to the server 102 and view ad impressions, coupon use and fees paid to the operators of the server 102 in exchange for the running the advertiser's ads and coupons. Processed data 270 may be processed so as to be viewed in total, by demographic data and by kiosk or mobile phone. Coupon use, for example, may be viewed by demographic data (thereby showing the demographics of the consumers that utilized the coupon) and by kiosk or mobile phone (thereby showing the amount of coupon use originated by each kiosk or mobile phone). Ad impressions, in another example, may be viewed by demographic data (thereby showing the demographics of the consumers that viewed the ad) and by kiosk or mobile phone (thereby showing the number of ads shown at each kiosk or mobile phone). In this way, the advertiser 112 can view trends, for example, which indicate the effectiveness of certain ads, coupons or other promotions and adjust his ad campaigns accordingly.

In another example, the location owner 114 may log on to the server 102 and view ad impressions, coupon use and revenue paid to the owner 114 by the operators of the server 102 in exchange for the placement of the kiosks 120-122. Processed data 270 may be processed so as to be viewed in total, by demographic data, by advertiser and by kiosk or mobile phone. The location owner 114 may view ad impressions, for example, by demographic data (thereby showing the demographics of the consumers that viewed the displayed ads), by advertiser (thereby showing which advertiser's ads were shown and their quantity) and by kiosk or mobile phone (thereby showing the number of ads shown in each kiosk or mobile phone). In this way, the location owner 114 can view how much each advertiser or kiosk contributes to his revenue and thereby adjust his efforts accordingly.

In yet another example, the administrator 110 may log on to the server 102 and view ad impressions, coupon use and revenue paid to the administrator 110 by the operators of the advertisers 112. Processed data 270 may be processed so as to be viewed in total, by demographic data, by advertiser, by location (i.e., by mall) and by kiosk or mobile phone. The administrator 110 may view revenue, for example, by demographic data (thereby showing the demographics of the consumers that viewed the displayed ads and used coupons, resulting in payment to the administrator 110), by advertiser (thereby showing which advertiser's ads were shown and their quantity, resulting in payment to the administrator 110) and by kiosk or mobile phone (thereby showing the number of ads shown in each kiosk or mobile phone, resulting in payment to the administrator 110). In this way, the administrator 110 can view trends, for example, which affect his revenue and make the necessary adjustments.

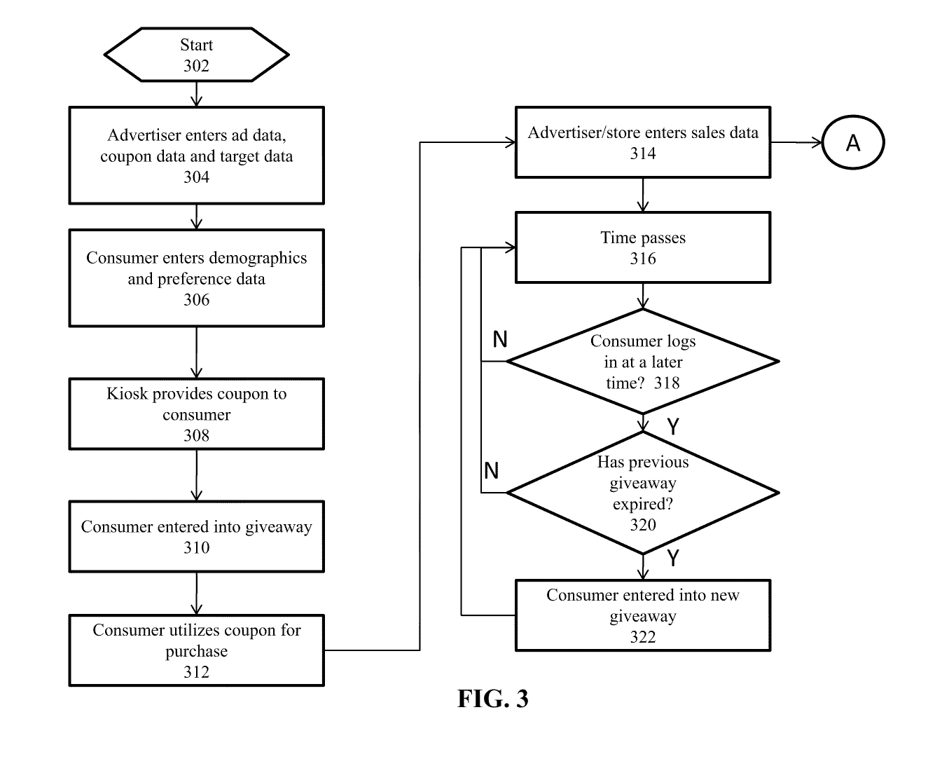

FIG. 3 is a flow chart describing the control flow of a process for providing targeted advertising to consumers over a communications network, in accordance with one embodiment of the present invention. The flow chart of FIG. 3 is described in association with FIG. 1 and FIG. 2 and depicts the process that is controlled by server 102, in accordance with one embodiment of the present invention.

In a first step 302, an advertiser 112 utilizes a computer 113 to enter ad data 202, such as graphics, video, text, a product identifier, a store identifier, an expiration date, etc. Advertiser 102 may also enter coupon data 204, further including a discount amount and a discount time period, and target data 206 specifying demographics to which the coupon or ad is targeted. Advertiser 102 may further enter survey questions 216. The data entered by the advertiser 112 is stored into repository 104.

In next step 306, consumer 101 enters demographics data 210, such as age, sex, income level and race, as well as preference data 212, such as preferred clothing type, preferred food type, and the reason for the consumer's current visit, into a kiosk 120. Additionally, the consumer 101 may enter answers 214 to survey questions provided to the consumer via the kiosk 120. The data entered by the consumer 101 is stored into repository 104.

In step 308, the kiosk 120 provides a coupon or ad to the consumer 101 based upon the demographic data 210, preference data 212 and survey answers 214 entered by the consumer 101, and further based upon the target data 206 entered by the advertiser 112. The coupon may be a printed paper coupon including a unique identifier or it may be a virtual coupon that is sent by text message or other electronic means to the consumer 101 on his mobile phone. For example, the coupon may be a virtual coupon that is sent electronic means, such as email, to the consumer 101 on his desktop or laptop computer.

In step 310, the consumer 101 is entered into a periodic sweepstakes or giveaway. In one alternative, the consumer 101 is entered into a periodic sweepstakes or giveaway only upon the validation of the coupon in step 314 below.

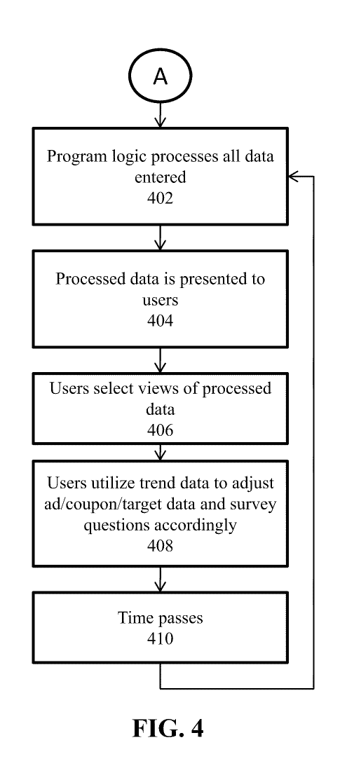

In step 312, the consumer 101 visits a store advertised by the coupon and makes a purchase at the store using the coupon. In step 314, sales data 208 is entered by the advertiser or store 112. The store 112 may log the coupon redemption and/or the related sale of merchandise into repository 104 via its client computer 111, a mobile app or a similar means. Step 314 also gives way to step A, which prompts the execution of the control flow of FIG. 4, defined in more detail below. In step 316, a time period passes. In step 318, if the consumer logs into the server 102 at a later time and the previous giveaway has expired (step 320), then the consumer 101 is entered into a new giveaway in step 322. The consumer 101 may log in at a later time by visiting a kiosk, or visiting an online site via his mobile phone or other computer, such as a workstation.

The process of FIG. 3 provides an incentive to the consumer 101 to utilize the coupon issued to him by providing a monetary discount and by offering a giveaway or sweepstakes. Further, the method provides an incentive for consumers to continuously log onto or visit the online location of server 102 by offering to enter the consumer 101 later or running sweepstakes and giveaways.

FIG. 4 is a flow chart describing the control flow of a process for managing advertising related data over a communications network, in accordance with one embodiment of the present invention. The flow chart of FIG. 4 is described in association with FIG. 1 and FIG. 2 and depicts the data management process that is controlled by server 102, in accordance with one embodiment of the present invention.

In a first step 402, the server 102 processes all of the data entered into repository 104 by the users, i.e., administrator 110, advertiser 112, location owner 114 and consumers 101, such as data sets 202-216 so as to produce processed data 270. In step 404, the processed data 270 is presented to the users via a workstation, i.e., 111, kiosk 120 or phone 130. In step 406, the user may select one or various views for viewing the processed data 270, as defined above.

For example, the advertiser 112 may select a view of the processed data 270 so as to be viewed in total, by demographic data and by kiosk or mobile phone. Coupon use, for example, may be viewed by demographic data and by kiosk or mobile phone. Ad impressions, in another example, may be viewed by demographic data and by kiosk or mobile phone. In this way, the advertiser 112 can view trends, for example, which indicate the effectiveness of certain ads, coupons or other promotions and adjust his ad campaigns accordingly in step 408. In step 410, a period of time passes the and control flow of FIG. 4 is executed once more starting at step 402.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for managing advertising related data over a distributed computer network, comprising:
receiving from an advertiser, via a network connection, at least one data record, wherein each data record defines a coupon and target data specifying demographics for targeting the coupon;
receiving from each of a plurality of consumers, via the network connection, identifying data, demographic data and purchase preference data;
providing to each of the plurality of consumers a coupon based on the demographic data of the consumer, the preference data of the consumer and the target data of the advertiser;
entering each of the plurality of consumers in a sweepstakes;
receiving, via the network connection, a plurality of validation notices confirming that a plurality of coupons was utilized by a subset of the plurality of consumers at the advertiser via a purchase;
receiving from an advertiser, via a network connection, a request to view aggregate data representing coupon provision and coupon validation; and
generating a data record including aggregate data representing coupon provision and coupon validation according to demographic data.

2. The method of claim 1, wherein the step of receiving from an advertiser at least one data record further comprises:
receiving from the advertiser, via the network connection, a data record defining an advertisement.

3. The method of claim 2, wherein the step of receiving from an advertiser at least one data record further comprises:
receiving from the advertiser, via the network connection, a data record defining a plurality of survey questions.

4. The method of claim 1, wherein the step of receiving from each of a plurality of consumers identifying data further comprises:
receiving from each of a plurality of consumers, via the network connection, answers to survey questions and a selection of symbols for entrance into a sweepstakes.

5. The method of claim 4, wherein the step of providing to each of the plurality of consumers a coupon further comprises:
providing to each of the plurality of consumers a printed paper coupon.

6. The method of claim 4, wherein the step of providing to each of the plurality of consumers a coupon further comprises:
providing to each of the plurality of consumers a coupon comprising textual data sent to each consumer's mobile phone.

7. The method of claim 5, wherein the step of entering each of the plurality of consumers in a sweepstakes further comprises:
entering each of the plurality of consumers in a sweepstakes based on the selection of symbols chosen by each consumer.

8. The method of claim 1, wherein the step of receiving a plurality of validation notices further comprises:
receiving, via the network connection, a plurality of validation notices confirming that a plurality of coupons was utilized by a subset of the plurality of consumers at the advertiser via a purchase, wherein each validation notice includes an identifier of the consumer utilizing the coupon, an identifier of a store in which the coupon is utilized and an identifier of an item purchased with the coupon.

9. The method of claim 1, wherein the step of receiving from an advertiser a request to view aggregate data further comprises:
receiving from an advertiser, via a network connection, a request to view aggregate data representing survey answers.

10. The method of claim 9, wherein the step of generating a data record further comprises:
generating a data record including aggregate data representing survey according to demographic data.

11. The method of claim 1, further comprising:
receiving from an advertiser, via a network connection, a request to view the aggregate data according to another observed statistic.

12. The method of claim 10, further comprising:
generating a data record including aggregate data representing coupon provision and coupon validation according to the observed statistic.

13. A computer system for managing advertising related data over a distributed computer network, comprising:
a processor configured for:
receiving from an advertiser, via a network connection, at least one data record, wherein each data record defines a coupon and target data specifying demographics for targeting the coupon;
receiving from each of a plurality of consumers, via the network connection, identifying data, demographic data and purchase preference data;
providing to each of the plurality of consumers a coupon based on the demographic data of the consumer, the preference data of the consumer and the target data of the advertiser; and
entering each of the plurality of consumers in a sweepstakes;
receiving, via the network connection, a plurality of validation notices confirming that a plurality of coupons was utilized by a subset of the plurality of consumers at the advertiser via a purchase;
receiving from an advertiser, via a network connection, a request to view aggregate data representing coupon provision and coupon validation; and
generating a data record including aggregate data representing coupon provision and coupon validation according to demographic data.

14. The computer system of claim 13, wherein the step of receiving from an advertiser at least one data record further comprises:
receiving from the advertiser, via the network connection, a data record defining an advertisement.

15. The computer system of claim 14, wherein the step of receiving from an advertiser at least one data record further comprises:
receiving from the advertiser, via the network connection, a data record defining a plurality of survey questions.

16. The computer system of claim 13, wherein the step of receiving from each of a plurality of consumers identifying data further comprises:
receiving from each of a plurality of consumers, via the network connection, answers to survey questions and a selection of symbols for entrance into a sweepstakes.

17. The computer system of claim 16, wherein the step of providing to each of the plurality of consumers a coupon further comprises:
providing to each of the plurality of consumers a printed paper coupon.

18. The computer system of claim 16, wherein the step of providing to each of the plurality of consumers a coupon further comprises:
providing to each of the plurality of consumers a coupon comprising textual data sent to each consumer's mobile phone.

19. The computer system of claim 18, wherein the step of entering each of the plurality of consumers in a sweepstakes further comprises:
entering each of the plurality of consumers in a sweepstakes based on the selection of symbols chosen by each consumer.

20. The computer system of claim 14, wherein the step of receiving a plurality of validation notices further comprises:
receiving, via the network connection, a plurality of validation notices confirming that a plurality of coupons was utilized by a subset of the plurality of consumers at the advertiser via a purchase, wherein each validation notice includes an identifier of the consumer utilizing the coupon, an identifier of a store in which the coupon is utilized and an identifier of an item purchased with the coupon.
